(19) United States
(12) Patent Application Publication
(10) Pub. No.: US 2026/0146001 A1
(43) Pub. Date: May 28, 2026

(54) COVERING ELEMENT AND A METHOD FOR MANUFACTURING A COVERING ELEMENT

(71) Applicant: MARAZZI GROUP SRL, Sassuolo (IT)

(72) Inventor: Lorenzo VALERIANI, Scandiano (IT)

(21) Appl. No.: 19/121,702

(22) PCT Filed: Oct. 16, 2023
(86) PCT No.: PCT/IB2023/060409

§ 371 Date: Apr. 16, 2025

(30) Foreign Application Priority Data
Oct. 20, 2022 (IT) 102022000021600

(51) Int. Cl. C04B 28/00; C04B 20/02; C04B 33/132; C04B 41/00; C04B 41/48

(52) U.S. Cl. CPC C04B 28/006; C04B 20/026; C04B 33/1324; C04B 41/009; C04B 41/48; C04B 2235/3427

(57) ABSTRACT

A method for making a covering element (1) comprising the phases of: preparing a geopolymerizable composition having a precursor (12) of sintered ceramic material, preferably obtained from a ceramic production process, and an activator (14); forming said composition to obtain a body (2); activating the geopolymer reaction of the composition; and optionally making a top layer (3) on said body (2), said top layer having at least one decorative layer (6).

The present invention relates to a covering element, preferably for floors or walls, and a method for making cladding elements. More specifically, the present invention relates to a cladding element comprising a body made of geopolymer material.

As is known, a geopolymer is an aluminosilicate material that is obtained at low temperatures by alkaline activation and that has an amorphous and/or partially crystalline structure. A geopolymer material comprises chains or a network of mineral molecules connected by covalent bonds. Geopolymer materials differ from cementitious materials in that they are fundamentally aluminum-based rather than calcium-based, and in the alkaline reaction used in their formation. Geopolymer materials are obtained by means of the curing reaction between an aluminosilicate precursor and an alkaline activator.

Examples of covering elements comprising geopolymer materials are described in FR 2528818, in which the method requires a heat treatment at temperatures of between 300° C. and 700° C. for several hours. EP 2727894 requires pre-activation of the precursor, formed primarily by clays, by calcination of the precursor, and provides for extrusion forming of the covering element with subsequent drying after curing. US 2007/0221100 describes a covering element made of geopolymer material obtained from blast furnace slag and fly ash.

One objective of the present invention is to propose an alternative covering element and an alternative method for making a covering element. These objectives are achieved by the features of the invention set out in the independent claims. The dependent claims set out preferred and/or particularly advantageous aspects of the invention.

A first independent aspect of the invention provides a covering element comprising a body made of geopolymer material. Said geopolymer material is obtained from a precursor and an activator, in which said precursor comprises, and preferably consists of, sintered ceramic powder. For example, said sintered ceramic powder comprises a waste product from a ceramic production process. Preferably, said ceramic production process is a production process for a covering element made of ceramic material. Using sintered powder makes it possible to start with a precursor that is at least partially amorphous or vitreous, which is more easily attacked by the activator. The inventor has found that using a precursor obtained from a ceramic production process can obviate the need for the thermal treatment that would otherwise be required to make the raw materials amorphous. Furthermore, by using waste products from a ceramic process, the precursor can be obtained at relatively low cost.

Preferably, the precursor can comprise mainly powder from porcelain stoneware, red stoneware, terracotta, single-fired white or red tiles. Porcelain stoneware is preferred from all of these as it has the greatest amorphous-phase content.

The precursor may have an amorphous-phase content greater than 50% by weight, for example greater than 60% by weight. The inventor has found that the aggression of the activator is more effective where the amorphous phase is larger.

Said precursor comprises ceramic powder obtained from cutting, grinding, sizing or polishing processes, or a combination thereof. In this solution, the precursor is initially particulate material with a granulometry that may be suitable for the geopolymer reaction without further processing, or may be a good starting point for subsequent milling of the precursor. The use of powder obtained from cutting or grinding is preferred to the use of powder obtained from sizing or polishing since, despite a lower amorphous-phase content, these have a higher SiO₂ content and are therefore more suited to the geopolymer reaction.

The activator is preferably alkaline and may comprise a hydroxide and/or a silicate of an alkali metal, preferably lithium (Li), potassium (K) and/or sodium (Na). Preferably, said activator may comprise, and preferably consist of, one or more of the elements in the group including potassium silicate, sodium silicate, lithium silicate, potassium hydroxide, and sodium hydroxide. Advantageously, the activator is used as a solution, preferably an aqueous solution. In the preferred embodiment, the activator substantially comprises a mixture of potassium silicate and potassium hydroxide, for example in a 1:1 ratio, to obtain covering elements with low water absorption, reduced efflorescence, and greater bending strength.

The covering element comprises a top layer arranged on a top surface of the body. The top layer is provided at least with a decorative layer.

The decorative layer, in the preferred embodiment, comprises decoration preferably printed by means of digital inkjet printing. The decoration can have any type of design, for example imitation wood, stone or marble. In the preferred embodiment, the decorative layer is printed directly onto the body. In the context of the present invention, “printed directly onto the body” means that the printing operation is carried out directly on the body, and not that the ink need necessarily be in contact with the surface of the body. Therefore, the expression “printed directly onto the body” does not exclude the presence of intermediate layers between the ink and the surface of the body, but does exclude the possibility of the print being made on a permanent or temporary substrate, such as a sheet of paper or polymeric material, and then transferred to the body. In some alternative embodiments, the decoration may be printed on a substrate, such as a sheet of paper or polymeric material, glued onto the top surface of the body. In the preferred embodiment, said decoration comprises pigment inks. Pigment inks have better resistance to ultraviolet radiation than soluble dye inks. Said pigments may have an organic or inorganic base. Inorganic pigments are preferable since they have better resistance to ultraviolet radiation. Said inks may be water-, solvent-, oil-, ultraviolet (UV)-, and/or electron-beam (EB)-based. Of these inks, UV or hybrid water/UV inks are preferable since they provide the best combination of cost, process speed, volatile-organic-compound (VOC) emissions, and print quality.

The top layer may also comprise one or more base layers arranged between the surface of the body and the decorative layer. Said base layers may comprise primers, base coloring and/or adhesion promoters. The base layers may be water-, solvent-, oil-, ultraviolet (UV)-, and/or electron-beam (EB)-based.

The top layer may also comprise one or more protective layers arranged on top of the decorative layer. Said protective layers may advantageously be transparent or translucent. The protective layers may be water-, solvent-, oil-, ultraviolet (UV)-, and/or electron-beam (EB)-based.

According to an alternative embodiment, one or more of said protective layers may comprise an inorganic material, for example a silicate or an aluminosilicate. For example, said protective layer of organic material may comprise sodium, potassium and/or lithium silicate. Said inorganic material may cure, forming a thin geopolymer layer during an ageing phase. The layer of inorganic material may have greater resistance against chemical attack and scratching compared to polymer coatings.

A second independent aspect of the invention provides a method for making cladding elements, for example according to the first independent aspect. In particular, the second independent aspect of the invention provides a method for making a covering element comprising the phases of: preparing a geopolymerizable composition having a precursor of sintered ceramic material, preferably obtained from a ceramic production process, and an activator; forming said composition to obtain a body; activating the geopolymer reaction of the composition; and optionally making a top layer on said body with at least one decorative layer.

For example, a first step of the method may involve preparing a manufactured ceramic object, preferably a tile; grinding said tile, preferably dry grinding, to produce a ceramic powder; and collecting said powder. According to alternative, less preferred embodiments of the method, grinding may be replaced by other operations such as lapping or polishing.

In the preferred embodiment, the ceramic powder may advantageously be wet milled, or preferably dry milled to increase the reactivity thereof.

The granulometry of the ceramic powder may have a d100 below 400 μm (i.e. 100% of the particles have a diameter of less than 400 μm), preferably below 350 μm, d90 below 50 μm, preferably below 35 μm, d50 below 15 μm, preferably below 7 μm, d10 below 2 μm, preferably below 1.5 μm.

The activator is advantageously added in the form of an aqueous solution. For example, the activator may be sprayed onto the precursor powder.

According to some embodiments, in the composition the activator makes up at least 10%, and preferably at least 20%, by weight with respect to the weight of the precursor.

In some embodiments, the composition may comprise water of hydration, for example more than 10% content by weight with respect to the weight of the precursor, preferably at least 15%.

The composition, before or after said hydration and/or addition of the activator, may be granulated to encourage better distribution of the composition inside a mold for a subsequent forming phase.

In the preferred embodiment, the body is formed by pressing. Although other forming techniques may be used, for example extrusion or casting, pressing results in a covering element with lower water absorption and requires less energy to remove the water of hydration.

Following the pressing phase, the composition is subjected to the geopolymer reaction activation phase, i.e. a first geopolymer reaction. The geopolymer reaction is activated at an activation temperature above 25° C., preferably above 40° C. Furthermore, the geopolymer reaction can be activated at an activation temperature below 140° C., preferably below 100° C. During said activation phase of the geopolymer reaction, the composition is kept at said activation temperature for an activation time equal to or greater than 24 hours, preferably greater than 48 hours. For example, said activation time is less than 200 hours, preferably equal to or less than 170 hours.

In some embodiments, during the activation phase, the activation temperature may vary according to a heating curve. For example, during this activation phase, the body of the covering element may be kept at a first activation temperature for a first activation period and subsequently at a second activation temperature for a second activation period. Preferably, said first activation temperature is lower than the second activation temperature. As a result, during the first activation period, the water of hydration may be slowly removed from the body, so as to limit the risk of defects such as efflorescence, fissures or cracks occurring in the body itself. In the subsequent activation period, the geopolymer reaction may be accelerated by the temperature increase.

Preferably, during activation, the composition is kept in an environment with relative humidity greater than 80%, preferably greater than 90%, for example equal to or greater than 95%. The inventor has found that the water of hydration may thus be slowly eliminated from the body during the activation phase, so as to limit the risk of defects such as efflorescence, fissures or cracks occurring in the body itself.

Said activation phase can be considered to be complete when the composition has reached a degree of geopolymerization at which the body has stiffened enough to achieve a mechanical resistance of at least 5 N/mm², for example of at least 6 N/mm². The geopolymer reaction is not finished once this mechanical strength has been achieved, but the body is rigid enough to withstand subsequent processes, such as application of the top layer or packaging of the body itself.

The method may therefore comprise one or more application phases for the base layers of the top layer. Said base layers may be applied using coating techniques, preferably wet, such as spray, roller or bell application. Preferably, following application of each base layer, a phase of at least partially curing or drying the recently applied base layer may be provided.

The decorative layer is preferably applied by inkjet printing directly on the body. Inkjet printing in the present invention is preferably carried out using inks containing pigments. Preferably, said inks are UV inks or hybrid water/UV inks. Following application of the decorative layer, a phase of at least partially curing or drying the decorative layer may be provided.

The method may therefore comprise one or more application phases for the protective layers of the top layer. Said protective layers may be applied using coating techniques, preferably wet, such as spray, roller or bell application. Preferably, following application of each protective layer, a phase of at least partially curing or drying said layer may be provided.

Following the application phase of the top layer, the covering element, or the body thereof, may be subjected to an ageing phase, or second geopolymer reaction to complete the reaction.

Advantageously, said ageing may occur at ambient temperature. Consequently, no further energy consumption is required. Said ageing may last at least 120 hours, preferably at least 144 hours. In the preferred embodiment, said ageing follows a boxing or packaging phase. Ageing therefore occurs substantially during storage of the covering element and does not affect the productivity of the method.

In some embodiments, before boxing, the covering element may be subjected to a grinding and/or squaring operation.

In alternative embodiments, the top layer may also be applied after the ageing phase. This enables a body to be retrieved from stock following receipt of a client order, decorated as required, and shipped, thereby simplifying stock management.

All of the features of the covering element relating to the first independent aspect of the invention, in particular the features of the geopolymer composition and of the top layer, can be applied to the method according to the second independent aspect, and vice versa.

Further features and advantages of the invention will become clear by reading the following examples, which are provided as non-limiting examples, with reference to the attached figures.

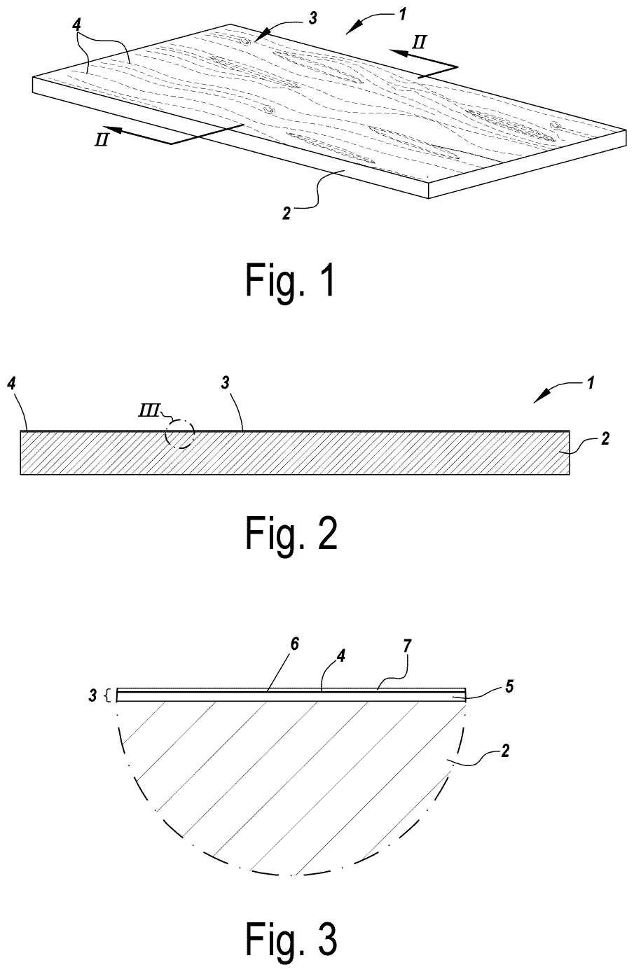

FIG. 1 is an axonometric view of a covering element according to the invention.

FIG. 2 is a magnified view of the section along the plane II-II in FIG. 1.

FIG. 3 is a magnified view of the detail F3 in FIG. 2.

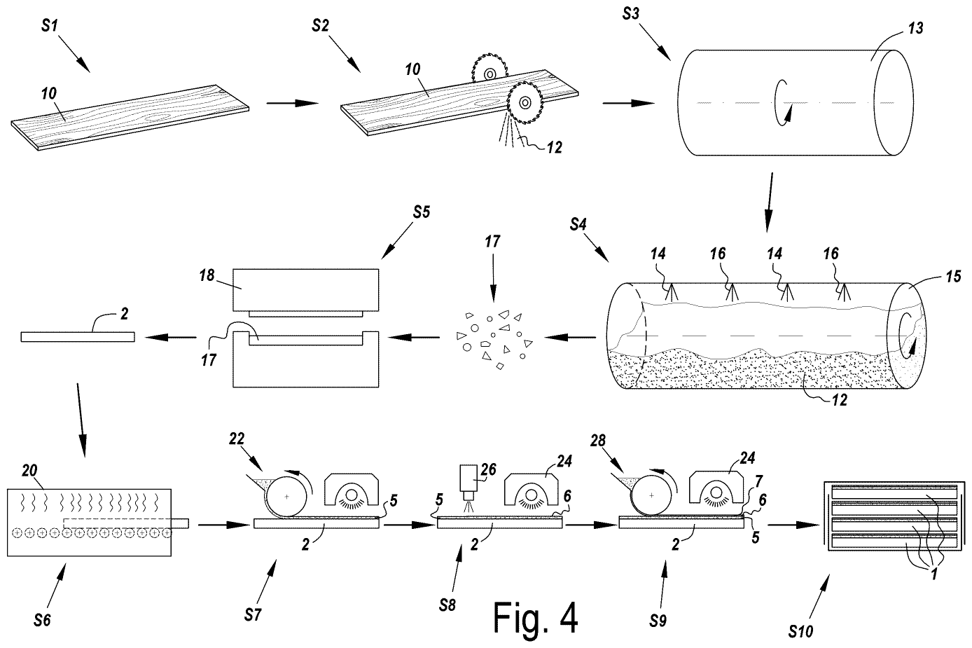

FIG. 4 is a schematic view of some steps of a method for making a covering element according to the invention.

FIGS. 1 and 2 show a covering element 1, for example a tile for cladding walls, having a body 2 and a top layer 3 provided with decoration 4, in the example imitation wood.

The body 2 is made of geopolymer material obtained from a starting geopolymer composition comprising a precursor obtained from a ceramic production process, in particular a porcelain stoneware powder.

As shown in FIG. 3, the top layer 3 comprises a base layer 5 interposed between the body 2 and a decorative layer 6 provided with the decoration 4. The base layer 5 is able to provide a base color for the decoration 4 and promotes adhesion of the decorative layer 5 to the surface of the body 2.

In the example, the base layer 5 is made of organic material, for example resin cured using UV radiation, and may comprise dyes or pigments, which are preferably inorganic.

The decorative layer 6 comprises a plurality of inkjet inks forming the decoration 4. The inks comprise color pigments, preferably inorganic pigments, and a binder cured using UV radiation.

As shown in FIG. 3, the top layer 3 further comprises a protective layer 7 arranged on top of the decorative layer 6. The protective layer 7 protects the decoration 4 from scratches, abrasion and chemical attack, and is preferably transparent or translucent.

In the example, the protective layer 7 is made of organic material, for example resin cured using UV radiation.

FIG. 4 shows some steps of a method for making the covering element 1 according to the second independent aspect of the invention.

The method shown in FIG. 4 comprises a first step S1 of preparing a starting tile 10, preferably made of porcelain stoneware. In the preferred example, said starting tile 10, for example after leaving a sintering kiln (not shown), is subjected to a grinding process S2, preferably dry grinding, to achieve the desired size. Said grinding process generates a waste ceramic powder 12.

The ceramic powder 12 is then milled in a milling process S3, preferably using a dry mill 13. In the example, the powder has the following granulometry: d100 below 400 μm (i.e. 100% of the particles have a diameter of less than 400 μm), preferably below 350 μm, d90 below 50 μm, preferably below 35 μm, d50 below 15 μm, preferably below 7 μm, d10 below 2 μm, preferably below 1.5 μm.

Said ceramic powder 12 will act as precursor in a geopolymer composition. To complete the composition, an activator 14 is sprayed onto the ceramic powder 12 in a step S4. The activator 14 in the preferred embodiment comprises potassium silicate and/or potassium hydroxide. The activator 14 is preferably added in the form of an aqueous solution. In the example, the activator 14 is added into a granulator 15 to encourage homogenization of the activator 14 with the precursor 12 and to obtain a composition granule 17.

The activator 14 makes up at least 10%, and preferably at least 20%, by weight with respect to the weight of the precursor.

In the example, the activator 14 is added to the composition together with water of hydration 16 inside a granulator 15. The granulator 15 is designed to mix and granulate the composition in a granulation step S4 to obtain composition granules 17.

The composition comprises water of hydration 16, for example more than 10% by weight with respect to the weight of the precursor, preferably at least 15%.

The composition granules 17 are inserted into a mold of a discontinuous press 18, and then pressed to form the body 2 in a step S5.

The formed body 2 is then subjected to an activation step S6 of the geopolymer reaction. In the example, the body 2 is placed in an oven 20 at a reaction temperature greater than 25° C., preferably greater than 40° C. The geopolymer reaction is activated at a reaction temperature below 140° C., preferably below 100° C. During said activation phase S6 of the geopolymer reaction, the composition is kept at said activation temperature for an activation time equal to or greater than 24 hours, preferably greater than 48 hours. For example, said activation time is less than 200 hours, preferably equal to or less than 170 hours.

In greater detail, in the example, during the activation phase, the body is kept at a first activation temperature (ITa) of 40° C. for a first activation period (IPa) of 24 hours, and is then kept at a second activation temperature (IIPa) of 85° C. for a second activation period (IIPa) of 144 hours.

At the end of said activation phase S6, the mechanical strength of the body is at least 5 N/mm², for example at least 6 N/mm².

The next step in the method is application of the top layer 3 to the body 2.

First of all, the base layer 5 is applied in a first coating step S7 by means of roller application of a base coating comprising an organic substance polymerizable with UV radiation, in a first coating station 22. Following application, the base layer 5 is partially cured using UV radiation with special lamps 24.

Following application of the base layer 5, the decorative layer 6 is applied using a single-pass inkjet printer 26 to apply UV inks comprising pigments in a printing step S8. Following application, the decorative layer is cured using UV radiation with special lamps 24 until the underlying base layer 5 is substantially completely polymerized and the decorative layer 6 is partially polymerized.

Finally, the protective layer 7 is applied in a second coating step S9 by means of roller application of a protective coating comprising an organic substance polymerizable with UV radiation, in a second coating station 28. Following application, the protective layer is cured using UV radiation with special lamps 24 until both the protective layer 7 and the underlying decorative layer 6 are substantially completely polymerized.

Once application of the top layer 3 is complete, the covering element 1 is boxed in a step S10, together with other previously manufactured covering elements, and kept in storage for at least 120 hours to enable completion of the geopolymer reaction.

### EXAMPLES

Some example covering elements 1 made using different compositions and/or curing conditions are set out below, for which water absorption, bending strength, and shrinkage have been measured. Water absorption is measured according to ISO 13006, and bending strength is measured according to ISO 10545.

| | PR | KH | KS | WC | ITa | IPa | IITa | IIPa | WA | MS | SH |
|---|---|---|---|---|---|---|---|---|---|---|---|
| EX | (g) | (g) | (g) | (g) | (° C.) | (h) | (° C.) | (h) | (%) | (N/mm²) | (%) |
| 1 | 150 | 30 | 30 | 22.5 | 40 | 24 | 85 | 144 | 1.36 | 22.3 | 6.1 |
| 2 | 150 | 20 | 30 | 22.5 | 40 | 24 | 85 | 144 | 1.88 | 21.5 | 6.1 |
| 3 | 150 | 30 | 20 | 22.5 | 40 | 24 | 85 | 144 | 2.10 | 20.3 | 6.5 |
| 4 | 150 | 40 | 40 | 25 | 40 | 24 | 85 | 144 | 1.25 | 25.6 | 6.8 |
| 5 | 150 | 30 | 40 | 25 | 40 | 24 | 85 | 144 | 1.15 | 26.3 | 6.9 |
| 6 | 150 | 40 | 30 | 25 | 40 | 24 | 85 | 144 | 1.42 | 24.3 | 6.8 |

Key:
EX: Example
PR: Precursor mass
KH: Potassium hydroxide mass
KS: Potassium silicate mass
WC: Water of hydration content
ITa: First activation temperature
IPa: First activation period
IITa: Second activation temperature
IIPa: Second activation period
WA: Water absorption
MS: Mechanical strength
SH: Shrinkage

The present invention is in no way limited to the embodiments described above, but said covering elements and systems may be made according to different variants without thereby departing from the scope of the present invention.

The invention is further defined by each of the following paragraphs:

1. A method for making a covering element comprising the phases of: preparing a geopolymerizable composition having a precursor of sintered ceramic material, preferably obtained from a ceramic production process, and an activator; forming said composition to obtain a body; activating the geopolymer reaction of the composition; and optionally making a top layer on said body with at least one decorative layer.

2. The method according to paragraph 1, in which said sintered ceramic material is porcelain stoneware.

3. The method according to either of paragraphs 1 and 2, in which said sintered ceramic material is waste powder from a grinding process.

4. The method according to any one of the preceding paragraphs, comprising a milling step of the ceramic powder, preferably dry milling.

5. The method according to any one of the preceding paragraphs, in which the granulometry of the ceramic powder has a d100 below 400 μm (i.e. 100% of the particles have a diameter of less than 400 μm), preferably below 350 μm, d90 below 50 μm, preferably below 35 μm, d50 below 15 μm, preferably below 7 μm, d10 below 2 μm, preferably below 1.5 μm.

6. The method according to any one of the preceding paragraphs, in which the activator is advantageously added in the form of an aqueous solution.

7. The method according to any one of the preceding paragraphs, in which the activator makes up at least 10%, and preferably at least 20%, by weight with respect to the weight of the precursor.

8. The method according to any one of the preceding paragraphs, in which the activator comprises a hydroxide and/or a silicate of an alkali metal, preferably potassium (K) and/or sodium (Na).

9. The method according to paragraph 8, in which said activator comprises, and preferably consists of, one or more of the elements in the group including potassium silicate, sodium silicate, potassium hydroxide, and sodium hydroxide.

10. The method according to either of paragraphs 8 and 9, in which the activator substantially comprises a mixture of potassium silicate and potassium hydroxide.

11. The method according to any one of the preceding paragraphs, in which the body is formed by pressing.

12. The method according to any one of the preceding paragraphs, comprising an activation phase of the geopolymer reaction, i.e. a first geopolymer reaction.

13. The method according to paragraph 12, in which said geopolymer reaction is activated at a reaction temperature above 25° C., preferably above 40° C. and/or a reaction temperature below 140° C., preferably below 100° C.

14. The method according to paragraph 13, in which, in said activation phase of the geopolymer reaction, the composition is kept at said reaction temperature for a reaction time equal to or greater than 24 hours, preferably greater than 48 hours and/or equal to or less than 200 hours, preferably less than 170 hours.

15. The method according to either of paragraphs 13 and 12, in which, in said activation phase, the composition is kept at a first activation temperature for a first activation period and subsequently at a second temperature for a second activation period, said first activation temperature preferably being lower than the second activation temperature.

15. The method according to any one of paragraphs 1 to 14, in which said activation phase ends when the composition has reached a degree of geopolymerization at which the body has stiffened enough to achieve a mechanical resistance of at least 5 N/mm², for example of at least 6 N/mm².

16. The method according to any one of paragraphs 12 to 15, comprising an ageing phase, or a second geopolymer reaction to complete the reaction.

17. The method according to paragraph 16, in which said ageing phase occurs at ambient temperature.

18. The method according to either of paragraphs 16 and 17, in which said ageing phase lasts at least 120 hours, preferably at least 170 hours.

19. The method according to any one of paragraphs 16 to 18, in which said ageing follows a boxing or packaging phase.

20. The method according to any one of paragraphs 16 to 19, in which said top layer is applied between said activation phase and before said ageing phase.

21. The method according to any one of paragraphs 16 to 19, in which said top layer is applied after said ageing phase.

22. The method according to any one of the preceding claims, characterized in that said top layer is made by applying organic substances that are preferably curable with UV radiation.

23. The method according to any one of the preceding claims, in which the application phase of the top layer comprises the application of one or more base layers before application of the decorative layer, said base layers preferably being curable with UV radiation.

24. The method according to any one of the preceding claims, in which the application phase of the top layer comprises the application of one or more protective layers after application of the decorative layer, said base layers preferably being curable with UV radiation.

1. A method for making a covering element comprising the phases of:
preparing a geopolymerizable composition having a precursor of sintered ceramic material, preferably obtained from a ceramic production process, and an activator;
forming said composition to obtain a body;
activating a geopolymer reaction of the composition; and
optionally making a top layer on said body, said top layer having at least one decorative layer.

2. The method as claimed in claim 1, wherein said sintered ceramic material is porcelain stoneware.

3. The method as claimed in claim 1, wherein said sintered ceramic material is waste powder from a grinding process.

4. The method as claimed in claim 1, wherein it comprises a milling step of the precursor, preferably dry milling.

5. The method as claimed in claim 1, wherein the granulometry of the precursor has a d100 below 400 μm, preferably below 350 μm, d90 below 50 μm, preferably below 35 μm, d50 below 15 μm, preferably below 7 μm, d10 below 2 μm, preferably below 1.5 μm.

6. The method as claimed in claim 1, wherein the activator is added in the form of an aqueous solution.

7. The method as claimed in claim 1, wherein the activator makes up at least 10%, and preferably at least 20%, by weight with respect to the weight of the precursor.

8. The method as claimed in claim 1, wherein the activator comprises a hydroxide and/or a silicate of an alkali metal, preferably potassium and/or sodium.

9. The method as claimed in claim 8, wherein said activator comprises, and preferably consists of, one or more of the elements in the group including potassium silicate, sodium silicate, potassium hydroxide, and sodium hydroxide.

10. The method as claimed claim 8, wherein the activator substantially comprises a mixture of potassium silicate and potassium hydroxide.

11. The method as claimed in claim 1, in which the body is formed by pressing.

12. The method as claimed in claim 1, comprising an activation phase of the geopolymer reaction.

13. The method as claimed in claim 12, in which said geopolymer reaction is activated at a reaction temperature above 25° C., preferably above 40° C. and/or a reaction temperature below 140° C., preferably below 100° C.

14. The method as claimed in claim 13, in which, in said activation phase of the geopolymer reaction, the composition is kept at said reaction temperature for a reaction time equal to or greater than 24 hours, preferably greater than 48 hours and/or equal to or less than 200 hours, preferably less than 170 hours.

15. The method as claimed in claim 12, in which, in said activation phase, the composition is kept at a first activation temperature for a first activation period and subsequently at a second temperature for a second activation period, said first activation temperature preferably being lower than the second activation temperature.

16. The method as claimed in claim 1, in which said activation phase ends when the composition has reached a degree of geopolymerization at which the body has stiffened enough to achieve a mechanical resistance of at least 5 N/mm², for example of at least 6 N/mm².

17. The method as claimed in claim 12, comprising an ageing phase, or a second geopolymer reaction to complete the reaction.

18. The method as claimed in claim 17, in which said ageing phase occurs at ambient temperature.

19. The method as claimed in claim 17, in which said ageing phase lasts at least 120 hours, preferably at least 170 hours.

20. The method according to claim 16, in which said top layer is applied between said activation phase and before said ageing phase.

21.-25. (canceled)
